(19) United States
(12) Patent Application Publication
(10) Pub. No.: US 2007/0167564 A1
(43) Pub. Date: Jul. 19, 2007

(54) HEAT CONDUCTIVE SILICONE COMPOSITION

(75) Inventors: CHING-TAI CHENG, Tu-Cheng (TW); NIEN-TIEN CHENG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO., LTD., Tu-Cheng (TW)

(21) Appl. No.: 11/309,251

(22) Filed: Jul. 20, 2006

(30) Foreign Application Priority Data
Jan. 18, 2006 (CN) 200610033268.0

(51) Int. Cl. C08L 83/04; B32B 27/00

(52) U.S. Cl. 524/588; 525/477; 525/478

(57) ABSTRACT

A heat conductive silicone composition comprises: (A) an alkenyl group-bearing organopolysiloxane, (B) an organohydrogenpolysiloxane having at least two Si—H groups therein, (C) a filler of aluminum powder or metal oxide powder, and (D) a coupling agent selected from titanate-based or aluminate-based coupling agent.

### FIELD OF THE INVENTION

The present invention relates to heat conductive compositions, and more specifically to heat conductive silicone compositions having an improved heat transfer ability for use with heat generating units.

### DESCRIPTION OF RELATED ART

With the continuing development of computer technology, electronic components such as central processing units (CPUs) of computers are being made to operate at higher operational speeds and to have greater functional capabilities. When a CPU operates at high speed in a computer enclosure, its temperature can increase rapidly. To avoid damage to the CPU, heat generated by the CPU must be dissipated quickly; this can be done by, for example, using a heat sink attached to the surface of the CPU contained in the enclosure. Dissipating the heat quickly allows the CPU and other high-performance electronic components contained in the enclosure to function within their normal operating temperature ranges, thereby assuring the quality of data management, storage and transfer from the CPU. Since the surface of the CPU or the surface of the heat sink is rough and air gaps exist at the contacting surfaces between the CPU and the heat sink, a thermal grease having a good heat transfer ability is employed between the CPU and the heat sink.

In the prior art, the thermal grease is obtained by mixing a base oil (such as silicone oil) and a thermoconductive inorganic filler. However, this kind of thermal grease suffers from the problem of oil bleeding during a long-term service. As a result, it is not suitable for direct application between the CPU and the heat sink.

Therefore, an improved heat conductive silicone composition which can overcome the above problem is desired.

### SUMMARY OF THE INVENTION

A heat conductive silicone composition comprises the following components (A)˜(D):

component (A): 100 parts by weight of an organopolysiloxane having at least two alkenyl groups in a molecule thereof, and having a viscosity of about 10˜100,000 mm2/s at 25° C.;

component (B): an organohydrogenpolysiloxane having at least two hydrogen atoms bonded directly to silicon atoms in a molecule thereof, an amount of component (B) being such that a ratio of the total number of hydrogen atoms bonded directly to silicon atoms in component (B) to the total number of alkenyl groups in component (A) is in the range of about 0.8/1˜1.5/1;

component (C): 500˜1200 parts by weight of a thermally conductive filler selected from aluminum powder and metal oxide powder; and

component (D): 0.01˜10 parts by weight of a coupling agent selected from titanate-based coupling agents and aluminate-based coupling agents.

Other advantages and novel features of the present invention can be drawn from the following detailed description of a preferred embodiment of the present invention, in which:

### DETAILED DESCRIPTION OF THE INVENTION

According to an embodiment of the present invention, the heat conductive silicone composition includes the following components: (A) an organopolysiloxane; (B) an organohydrogenpolysiloxane; (C) a filler; and (D) a coupling agent.

The organopolysiloxane of component (A) has at least two alkenyl groups in a molecule, each of the alkenyl groups being directly attached to a silicon atom. The organopolysiloxane may be either straight or branched. A mixture of two or more organopolysiloxanes having different viscosities is acceptable. The preferred embodiment of the alkenyl group is ethylene, 1-butylene or 1-hexylene. Component (A) is preferred to have a viscosity in the range of 10 to 100,000 mm2/s when the temperature is at 25° C. The amount of component (A) is 100 parts by weight.

The organohydrogenpolysiloxane of component (B) has at least two, preferably at least three, hydrogen atoms bonded directly to silicon atoms (i.e. Si—H groups) in a molecule. The Si—H groups in component (B) react with the alkenyl groups in component (A) to form a network structure, thereby enhancing the stability of the composition and avoiding the oil bleeding problem during long-term service. To reach the necessary cured hardness, the amount of component (B) blended is such that the ratio of the number of Si—H groups in component (B) to the number of alkenyl groups in component (A) should preferably be in the range of 0.8/1 to 1.5/1.

The filler of component (C) is used to impart the thermal conductivity of the composition. The filler is selected from metal powder, metal oxide powder or other inorganic powders. The mean particle size of the filler directly affects the viscosity of the composition; for this reason, the filler used herein preferably has a mean particle size of 0.1 to 100 μm. The preferred embodiment of component (C) is an aluminum powder having a mean particle size of 0.5 to 10 μm, a zinc oxide powder having a mean particle size of 0.1 to 5.0 μm, or a mixture of an aluminum powder having a mean particle size of 0.5 to 10 μm and a zinc oxide powder having a mean particle size of 0.1 to 5.0 μm. The amount of component (C) is 500 to 1200 parts by weight.

The coupling agent of component (D) is applied for enhancing the compatibility of the composition, and improving the dispersibility of the component (C) in the composition. Component (D) also lowers the viscosity of the composition. The coupling agent can be selected from either titanate-based coupling agents or aluminate-based coupling agents. Specific examples of the titanate-based coupling agents include isopropyltriisostearoyl titanate, isopropyl tris(dioctylpyrophosphate) titanate, isopropyltri(N-amidoethyl, aminoethyl) titanate, tetraoctylbis(ditridecylphosphate) titanate, tetra(2,2-diallyloxymethyl-1-butyl)bis(ditridecyl)phosphate titanate, bis(dioctylpyrophosphate)oxyacetate titanate, bis(dioctylpyrophosphate)ethylene titanate, isopropyltrioctanoyl titanate, isopropyldimethacrylisostearoyl titanate, isopropyltridodecylbenzenesulfonyl titanate, isopropylisostearoyidiacryl titanate, isopropyltri(dioctylphosphate) titanate, isopropyltricumylphenyl titanate, and tetraisopropylbis(dioctylphosphite) titanate. Examples of the aluminate-based coupling agent include alkylacetoacetate aluminum di-isopropylate. The amount of component (D) is about 0.01˜10 parts by weight.

Preferably, a catalyst (component (E)) selected from platinum or platinum compounds is added to the composition, wherein the catalyst serves to promote addition reaction between the alkenyl groups in component (A) and the Si—H groups in component (B). Exemplary catalysts are elemental platinum, chloroplatinic acid, platinum-olefin complexes, platinum-alcohol complexes, and platinum coordinated compounds. An appropriate amount of the catalyst is such that 0.1 to 500 parts by weight of platinum atoms among the catalyst is added to per million parts by weight of component (A). In the absence of component (E), the addition reaction between component (A) and component (B) may be slowed down; however, a higher temperature will promote the addition reaction therebetween, and increase the curing rate of the composition.

The heat conductive silicone composition is obtained by mixing the foregoing components (A) to (D) and optional components such as component (E) at room temperature.

The heat conductive silicone composition has a good extensibility, and before being cured, the composition should preferably have a viscosity in the range of 10 to 1,000 Pa·s when the temperature is at 25° C. The viscosity of the composition depends on the extent of reaction between component (A) and component (B), and if component (E) is not used, the curing rate is relatively low and accordingly the composition has a relatively low viscosity.

In use, the heat conductive silicone composition is applied between a heat generating unit such as a CPU and a heat sink. The composition is located and compressed between the heat generating unit and the heat sink, and completely fills the gap between the heat generating unit and the heat sink to increase contact surface area between the heat generating unit and the heat sink. The composition being applied is preferred to has a thickness in the range of 10˜100 μm.

The curing rate of the composition increases with the increase of the temperature in the heat generating unit, but the reaction between component (A) and component (B) is cross-linked polyaddition; thus, the volume of the composition remains constant, and will not reduce the thermal contact between the heat generating unit and the heat sink. The cross-linked polyaddition in the composition prevents oil bleeding from happening in the composition during long-term service.

### EXAMPLE

The composition will now be specifically described with reference to an example whose components are given below:

component (A): 100 parts by weight of an organopolysiloxane which has at least two alkenyl groups in a molecule, component (A) having a viscosity in the range of 10 to 100,000 mm2/s when the temperature is at 25° C.;

component (B): an organohydrogenpolysiloxane which can be represented by the following general formula:

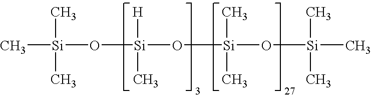

component (C): an aluminum powder having a mean particle size of 2 μm; and

component (D): isopropyltriisostearoyl titanate.

In this example, the composition is prepared by mixing component (A), component (B), component (D) in the blending proportions shown in Table 1 below under room temperature, wherein component (A) and component (B) are cross-linked. Component (C) is then added to the mixture in the blending proportion shown in Table 1, and the composition is thereby obtained.

Next, the prepared composition is sandwiched between two standard aluminum plates, with a pressure of approximately 1.8 kg/cm2 being applied thereto, and then is kept at a temperature of 75° C. for 30 days. The thermal resistance of the composition is measured by using a thermal resistance gauge (Mode LW-9091IR; LongWIN Co., Ltd.). The results of measurement tests are shown in Table 1.

TABLE 1

| Components | Example |
|---|---|
| Alkenyl group containing Organopolysiloxane | 6.6327 g |
| Si—H group-containing Organohydrogenpolysiloxane | 6.6327 g |
| Aluminum Powder (2 μm) | 36.7347 g |
| Titanate-based Coupling Agent | 0.3673 g |
| Thermal Resistance (K · cm²/W) | 0.276 |
| After 30 days at 75° C. was oil-bleeding detected? | NO |

### Comparative Example

A comparative composition is prepared using components shown in Table 2. These components are mixed in proportions given in Table 2. The results of measurement tests are shown in Table 2.

TABLE 2

| Components | Comparative Example |
|---|---|
| Dimethyl Silicon Oil | 13.2653 g, Viscosity = 50 cps |
| Aluminum Powder (2 μm) | 36.7347 g |
| Titanate-based Coupling Agent | 0.3673 g |
| Thermal Resistance (K · cm²/W) | 0.328 |
| After 30 days at 75° C. was oil-bleeding | YES |
| detected? | |

The test results in Table 1 and Table 2 show that the composition according to the example of the present invention has a good stability and a low thermal resistance, and the composition prevents oil bleeding problems during long-term service.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A heat conductive silicone composition comprising the following components (A)˜(D):
component (A): 100 parts by weight of an organopolysiloxane having at least two alkenyl groups in a molecule thereof, and having a viscosity of about 10˜100,000 mm2/s at 25° C.;
component (B): an organohydrogenpolysiloxane having at least two hydrogen atoms bonded directly to silicon atoms in a molecule thereof, an amount of component (B) being such that a ratio of the total number of hydrogen atoms bonded directly to silicon atoms in component (B) to the total number of alkenyl groups in component (A) is in the range of about 0.8/1˜1.5/1;
component (C): 500˜1200 parts by weight of a thermally conductive filler selected from aluminum powder and metal oxide powder; and
component (D): 0.01˜10 parts by weight of a coupling agent selected from titanate-based coupling agents and aluminate-based coupling agents.

2. The composition according to claim 1, further comprising a component (E), component (E) being a catalyst selected from elemental platinum and platinum compounds, 0.1˜500 ppm (parts per million) relative to component (A) calculated in terms of platinum atoms.

3. The composition according to claim 1, wherein component (C) having an mean particle size of 0.1˜100 micrometers.

4. The composition according to claim 1, wherein the alkenyl group of component (A) is selected from one of ethylene, 1-butylene and 1-hexylene.

5. The composition according to claim 3, wherein component (C) is selected from one of an aluminum powder having a mean particle size of 0.5 to 10 μm, a zinc oxide powder having a mean particle size of 0.1 to 5 μm, and a mixture of an aluminum powder having a mean particle size of 0.5 to 10 μm and a zinc oxide powder having a mean particle size of 0.1 to 5 μm.

6. The composition according to claim 1, wherein the titanate-based coupling agent is selected from the group consisting of isopropyltriisostearoyl titanate, isopropyl tris(dioctylpyrophosphate) titanate, isopropyltri(N-amidoethyl, aminoethyl) titanate, tetraoctylbis(ditridecylphosphate) titanate, tetra(2,2-diallyloxymethyl-1-butyl) bis(ditridecyl)phosphate titanate, bis(dioctylpyrophosphate)oxyacetate titanate, bis(dioctylpyrophosphate)ethylene titanate, isopropyltrioctanoyl titanate, isopropyldimethacrylisostearoyl titanate, isopropyltridodecylbenzenesulfonyl titanate, isopropylisostearoyidiacryl titanate, isopropyltri(dioctylphosphate) titanate, isopropyltricumylphenyl titanate, and tetraisopropylbis(dioctylphosphite) titanate.

7. The composition according to claim 1, wherein the aluminate-based coupling agent is alkylacetoacetate aluminum di-isopropylate.

8. The composition according to claim 2, wherein component (E) is selected from the group consisting of elemental platinum, chloroplatinic acid, platinum-olefin complexes, platinum-alcohol complexes, and platinum coordinate compounds.
